(19) United States
(12) Patent Application Publication
(10) Pub. No.: US 2026/0009660 A1
(43) Pub. Date: Jan. 8, 2026

(54) PHOTONIC-INTEGRATED DISTRIBUTED ACOUSTIC SENSING SYSTEM WITH LONG-DISTANCE AND WIDE-FREQUENCY RESPONSE

(71) Applicant: NANJING UNIVERSITY, Nanjing (CN)

(72) Inventors: Yixin ZHANG, Nanjing (CN); Xiaoyu ZHAO, Nanjing (CN); Xuping ZHANG, Nanjing (CN); Ningmu ZOU, Nanjing (CN); Teng MA, Nanjing (CN); Wei JIANG, Nanjing (CN); Xiangfei CHEN, Nanjing (CN)

(73) Assignee: NANJING UNIVERSITY, Nanjing (CN)

(21) Appl. No.: 19/189,317

(22) Filed: Apr. 25, 2025

Related U.S. Application Data
(63) Continuation of application No. PCT/CN2024/105192, filed on Jul. 12, 2024.

(30) Foreign Application Priority Data
Jul. 3, 2024 (CN) 20241088886.1

(51) Int. Cl. G01D 5/353; G01H 9/00

(52) U.S. Cl. CPC G01D 5/35358; G01H 9/004

(57) ABSTRACT

A photonic-integrated distributed acoustic sensing system (DAS) with long-distance and wide-frequency response includes: a low-voltage DC electric drive module, an optical transmitter chip, an integrated optical amplification module, an optical receiver chip, a signal conditioning and acquisition chip, and a digital signal processing chip that are sequentially connected. The photonic-integrated DAS system has the features of extended monitoring distance, broad frequency response bandwidth, high signal fidelity, ultra-sensitive detection capabilities, low power consumption, compact form factor, and robust environmental adaptability.

### CROSS REFERENCE TO THE RELATED APPLICATIONS

This application is a continuation application of International Application No. PCT/CN2024/105192, filed on Jul. 12, 2024, which is based upon and claims priority to Chinese Patent Application No. 202410888886.1, filed on Jul. 3, 2024, the entire contents of which are incorporated herein by reference.

### TECHNICAL FIELD

The present invention relates to the field of optical fiber sensing technology, in particular to a photonic-integrated distributed acoustic sensing system with long-distance and wide-frequency response.

### BACKGROUND

A sensing parameter of distributed acoustic sensing (Distributed acoustic sensing, DAS) is a vibrating acoustic wave signal. Therefore, a sensing fiber does not need to be in close contact with a measured object, and may sense a target state through a sound field signal propagated by a medium. Through detection of vibrating acoustic waves of large-scale infrastructure, structural damage information can be captured, features and information of a vibration source can be accurately restored, and a damage evolution law and a failure mechanism of the large-scale infrastructure during service can be quantitatively revealed. Therefore, the DAS is considered to be the most practical distributed acoustic sensing technology for non-destructive detection of the large-scale infrastructure.

At present, there is a large mismatch between performance envelope of a DAS device based on discrete devices and requirements of typical applications, and a sensing distance, a frequency response, a dynamic range, and sensitivity in the DAS system are limited by an underlying mechanism, and there is a mutual constraint relationship. Early warning of risks for all kinds of large-scale infrastructure usually requires a dynamic response, a large dynamic range, and ultra-sensitive detection capabilities. In addition, in some complex environments, higher requirements are required for the performance of the system, such as signal fidelity, sensing sensitivity, a size, a weight, power consumption, and environmental adaptability.

Therefore, it is an urgent problem for a person skilled in the art to resolve difficulties in the prior art by proposing a photonic-integrated distributed acoustic sensing system with long-distance and wide-frequency response.

### SUMMARY

In view of this, the present invention provides a photonic-integrated distributed acoustic sensing system with long-distance and wide-frequency response, to resolve problems in the prior art.

To achieve the foregoing objectives, the following technical solutions are used in the present invention.

A photonic-integrated distributed acoustic sensing system with long-distance and wide-frequency response is provided, including: a low-voltage direct current (DC) electric drive module, an optical transmitter chip, an integrated optical amplification module, an optical receiver chip, a signal conditioning and acquisition chip, and a digital signal processing chip that are sequentially connected, where
the optical transmitter chip is configured to synthesize pulse sequences including a plurality of different wavelengths required by the DAS system;
the integrated optical amplification module includes an optical power amplifier, an optical circulator, and a low-noise optical amplifier that are sequentially connected, where the optical circulator is further connected to a sensing fiber; the optical power amplifier is connected to an optical pulse modulator, to increase the peak power of the pulse; the pulse is injected into the sensing fiber through the optical circulator, and a backscattering optical signal returned by the optical circulator further includes a plurality of wavelengths due to the fact that the pulse injected into the sensing fiber includes a plurality of wavelengths; and the backscattering optical signal is amplified through the low-noise optical amplifier, to obtain an amplified multi-wavelength optical signal;
the optical receiver chip is configured to realize the separation and detection of multi-channel scattering lights in a mechanism of wavelength division, to obtain a photoelectric sounding signal;
the signal conditioning and acquisition chip is configured to perform amplification, filtering, and quantization on the photoelectric sounding signal, to obtain an independent n-channel demodulation result;
the digital signal processing chip is configured to perform demodulation, multi-dimensional feature extraction, pattern recognition, human-computer interaction, and data communication; and
the low-voltage DC electric drive module is configured to drive and control the optical transmitter chip, the integrated optical amplification module, the optical receiver chip, the signal conditioning and acquisition chip, and the digital signal processing chip that are sequentially connected.

According to the foregoing system, optionally, the optical transmitter chip includes an array of narrow-linewidth light sources and the optical pulse modulator that are sequentially connected, where
the array of narrow-linewidth light sources is configured to output pulsed light at different frequencies; and
the optical pulse modulator is configured to process the pulsed light at different frequencies output by the array of narrow-linewidth light sources, including single-sideband frequency modulation and pulse shaping of intensity modulation, to obtain probe pulses in a mechanism of wavelength division and multi-domain multiplexing measurement.

According to the foregoing system, optionally, the pulsed light is processed based on serial cascade modulation, to make an extinction ratio meet requirements of the DAS system, including the following steps:
(1) alternately turning on each laser inside the array of narrow-linewidth light sources at equal intervals in time domain, to form a pulse with the width of us, and achieve the central wavelength of the laser precisely through the reconstruction-equivalent chirp (REC) grating technology;
(2) combining the pluses of n wavelengths generated by a multi-wavelength laser array by a wavelength division multiplexer, thus forming a pulse sequence in time sequence;
(3) dividing a frequency-stable region inside the pulsed light into two symmetrical halves through external time-synchronous modulation, where the frequency of the last half of the pulse will be shifted by Δf, so that a chirp region with a continuous frequency change and two stable regions with frequencies fand f+Δf are formed in a single pulse; and
(4) by using a broadband Mach Zehnder M Z modulator structure, precisely balancing the loss of two arms of a Mach Zehnder interferometer, to achieve high extinction ratio pulse shaping of multiple wavelength pulse signals provided by the laser array chip simultaneously; removing the chirp region; and further chopping the frequency-stable region into two sub-pulses of frequencies fand f+Δf with better rectangular coefficients, where each of pulse widths of the two generated sub-pulses is reduced to tens of ns, with an interval of hundreds of ns.

According to the foregoing system, optionally, the frequency difference Δf of two sub-pulses and a pulse width τ meet the following relationship:

$$Δ f > \frac{1}{τ} .$$

According to the foregoing system, optionally, the optical receiver chip includes a wavelength division demultiplexer and a plurality of photodetectors connected in parallel with the wavelength division demultiplexer;
the wavelength division demultiplexer is connected to the low-noise optical amplifier; and
the wavelength division demultiplexer separates the multi-wavelength optical signal after low-noise optical amplification into independent n-channel output signals, and then performs photoelectric conversion on the multi-wavelength optical signal into an electrical signal through the plurality of photodetectors arranged in parallel.

According to the foregoing system, optionally, the signal conditioning and acquisition chip includes a plurality of signal conditioning and acquisition branches with a same quantity as the photodetectors, each signal conditioning and acquisition branch includes a trans-impedance amplifier, a band-pass filter, and an analog-to-digital converter that are sequentially connected, and the trans-impedance amplifier is connected to the photodetector.

According to the foregoing system, optionally, the digital signal processing chip includes a digital demodulator, a reconfigurable neural network, and a microprocessor core that are sequentially connected.

According to the foregoing system, optionally, the optical transmitter chip is generated by compound semiconductor technology, the optical receiver chip is generated by silicon photonic process, and functional parts inside the optical transmitter chip and functional parts inside the optical receiver chip are bonded by photonic wire bonding (PWB), and the optical transmitter chip to the single-mode optical fiber and the optical receiver chip to the single-mode optical fiber are bonded by photonic wire bonding (PWB) as well;
the optical transmitter chip and the optical receiver chip are close in space and merged into a unified package, and electrical pins are directly bound to a circuit board through a wire bonder after the chips are packaged;
pumping light sources in the optical transmitter chip, the optical receiver chip, and the integrated optical amplification module are concentrated in a specific area on the circuit board for unified constant temperature control; and
the low-voltage DC electric drive module performs centralized control on the transmitter chip, the integrated optical amplification module, the optical receiver chip, the signal conditioning and acquisition chip, and the digital signal processing chip in the system, and functions include temperature control, abnormal protection, gain stability, power drive, and timing control, and dedicated functions of human-machine interface, watchdog, low-power sleep, and high-precision reference are further included.

According to the foregoing system, optionally, the signal conditioning and acquisition chip is soldered onto the circuit board in the form of a single chip of hybrid circuits; the digital signal processing chip is soldered onto the circuit board in the form of a single chip of pure digital circuits; and the two chips are interconnected through microstrip lines on the circuit board.

A photonic-integrated distributed acoustic sensing system with long-distance and wide-frequency response is provided, applied to the photonic-integrated distributed acoustic sensing system with long-distance and wide-frequency response according to any one of claims 1 to 9, and including the following steps:
S1: output optical signals of n wavelengths with a specific sequence in terms of time by an optical transmitter chip, where an optical signal of each wavelength is a sub-pulse of two frequencies fand f+Δf, with an interval of hundreds of ns,
S2: increase the peak power of optical pulses by a power amplifier, and inject the pulse into a sensing fiber through an optical circulator;
S3: return a backscattering optical signal carrying event information through the optical circulator, and perform amplification by a low-noise optical amplifier;
S4: separate the received backscattering optical signal into independent n-channel outputs by a wavelength division demultiplexer in an optical receiver chip, where the optical signal from each channel is the superposition of two frequencies fand f+Δf,
S5: separately perform photoelectric conversion on signals of various wavelengths by a detector array in the optical receiver chip, and record a beat frequency signal carrying phase information;
S6: perform amplification, filtering, and quantization on an electrical signal by a signal conditioning and acquisition chip after photoelectric conversion is performed, and send the electrical signal to a digital signal processing chip; and
S7: perform processing and reconstruction on sensing data obtained by multi-channel frequency division interweaving by the digital signal processing chip.

According to the foregoing technical solution, it can be learned that, compared with the prior art, the present invention provides a photonic-integrated distributed acoustic sensing system with long-distance and wide-frequency response, and has the following beneficial effects:
(1) According to a photonic integration route, core functional components of the DAS system adopt a single-chip integration method, and the chips and the chip to a single-mode optical fiber are bonded by photonic wire bonding. This greatly meets the requirements of the DAS in terms of size, weight, power consumption, reliability, and environmental adaptability in different application scenarios.
(2) The system uses a laser array chip and an array detector, to realize a mechanism of wavelength division, to break through constraints between a sensing distance and a detection pulsed light transmission frequency, and improve an upper limit of a frequency response, a dynamic range, and detection sensitivity of a sensing instrument by using a higher pulse transmission frequency.
(3) The top-level solution of the sensing system is optimized, and shaping of external pulse modulation, serial cascade modulation, and another solution are used, to greatly lower harsh requirements of an existing technical means on the linewidth of the light source, and equivalently obtain a detection light pulse with a high extinction ratio, so that performance indicators of the photonic integrated chip meet the requirements of the DAS system.
(4) The demodulated information of the system includes three dimensions of wavelength, space, and time, and through the continuous dynamic optimization of multi-channel synchronous independent measurement results, the influence of fading noise can be suppressed, the signal with high precision can be reconstructed, and the sensitivity of the signal can be improved.
(5) The drive and power supply of each module in the system are merged according to functions, and the low-voltage DC power supply is used to perform centralized control on modules, to avoid the functional redundancy of the existing solution, suppress interference, and reduce the size and power consumption.

### BRIEF DESCRIPTION OF THE DRAWINGS

To describe technical solutions in embodiments of the present invention or in the prior art more clearly, the following briefly introduces accompanying drawings required for describing the embodiments or the prior art. It is clear that the accompanying drawings in the following descriptions are only some embodiments of the present invention, and a person of ordinary skill in the art may still derive other drawings from the accompanying drawings without creative efforts.

FIG. 1 is a block diagram of a structure of a photonic-integrated distributed acoustic sensing system with long-distance and wide-frequency response;

FIG. 2 is a flowchart of a photonic-integrated distributed acoustic sensing system with long-distance and wide-frequency response according to the present invention;

FIG. 3 is a schematic diagram of a detection pulsed light synthesis solution in a mechanism of wavelength division and multi-domain multiplexing measurement according to the present invention; and

FIG. 4 is a flowchart of DAS signal processing in a mechanism of wavelength division and multi-domain multiplexing measurement according to the present invention.

### DETAILED DESCRIPTION OF THE EMBODIMENTS

The following clearly and completely describes the technical solutions in embodiments of the present invention with reference to the accompanying drawings in embodiments of the present invention. It is clear that the described embodiments are merely some but not all of embodiments of the present invention. All other embodiments obtained by a person of ordinary skill in the art based on embodiments of the present invention without creative efforts shall fall within the protection scope of the present invention.

In this application, relational terms such as first and second are only used to distinguish one entity or operation from another entity or operation, and do not necessarily require or imply that any actual relationship or sequence exists between these entities or operations. The terms “include”, “including”, or any other variant thereof is intended to cover a non-exclusive inclusion, so that a process, a method, an article, or a device that includes a list of elements not only includes those elements but also includes other elements that are not expressly listed, or further includes elements inherent to such a process, method, article, or device. An element preceded by “includes a” does not, without more constraints, preclude the presence of additional identical elements in the process, method, article, or device that includes the element.

In view of insurmountable technical obstacles faced by the DAS technology based on discrete devices in the improvement of a sensing distance, a frequency response, signal guarantee, sensing sensitivity, a size, a weight, power consumption, environmental adaptability, and the like, in the present invention, according to the photonic integration route, an optical transmitter chip is generated by compound semiconductor technology, and the optical receiver chip is generated by silicon photonic process. The top-level solution of the sensing system is optimized, and the performance requirements of photonic integrated components meet the requirements of the DAS system through multi-domain multiplexing, serial cascade modulation, and the like. In terms of data processing, parallel demodulation, slot interleaving, phase demodulation, signal interpolation and another operation are performed on multi-channel sensing data, and the method in terms of wavelength, space, and time are comprehensively used to realize the continuous dynamic optimization of multi-channel synchronous independent measurement results, suppress the influence of fading noise, and reconstruct the signal with high precision. The drive and power supply of each module in the system are merged according to functions, and the low-voltage DC electric drive module performs centralized control on other modules in the system, to reduce redundancy, suppress interference, and reduce a size and power consumption. The specific technical solution is as follows.

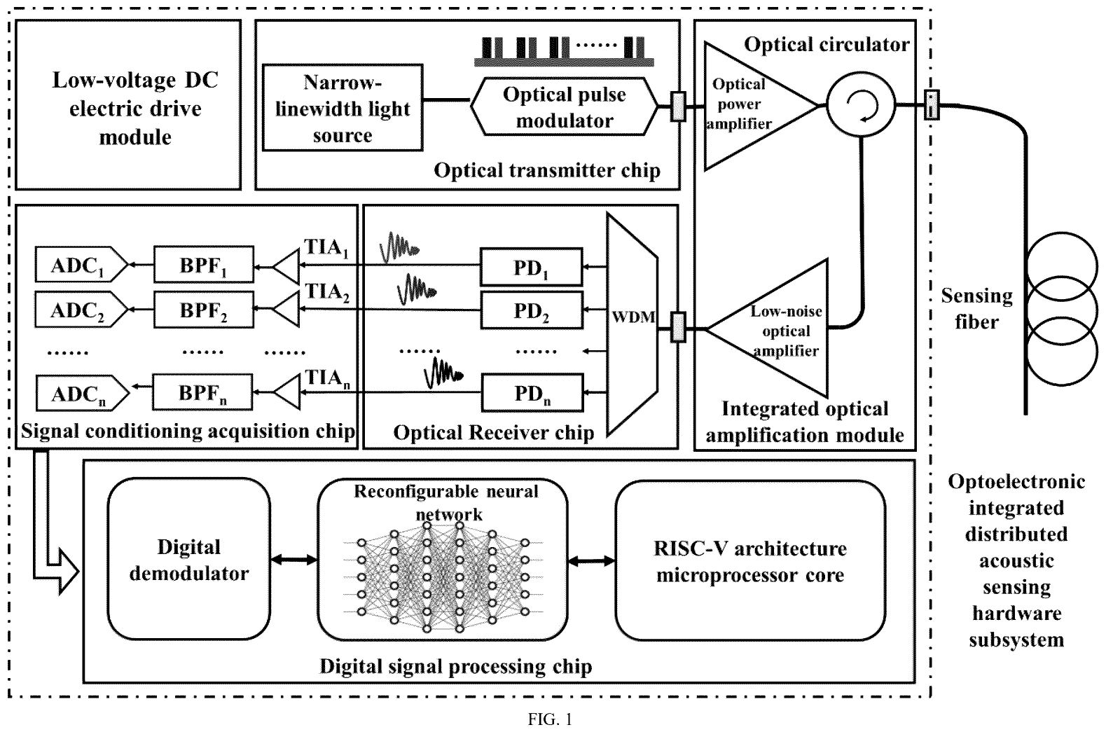

Refer to FIG. 1, the present invention discloses a photonic-integrated distributed acoustic sensing system with long-distance and wide-frequency response is provided, including: a low-voltage DC electric drive module, an optical transmitter chip, an integrated optical amplification module, an optical receiver chip, a signal conditioning and acquisition chip, and a digital signal processing chip that are sequentially connected, where
the optical transmitter chip is configured to synthesize pulse sequences including a plurality of different wavelengths required by the DAS system;
the integrated optical amplification module includes an optical power amplifier, an optical circulator, and a low-noise optical amplifier that are sequentially connected, where the optical circulator is further connected to a sensing fiber; and the optical power amplifier and the low-noise optical amplifier are referred to as an optical power amplifier and a low-noise optical amplifier in FIG. 1;
the optical power amplifier is connected to an optical pulse modulator, to increase the peak power of the pulse; the pulse is injected into the sensing fiber through the optical circulator, and a backscattering optical signal returned by the optical circulator further includes a plurality of wavelengths due to the fact that the pulse injected into the sensing fiber includes a plurality of wavelengths; and the backscattering optical signal is amplified through the low-noise optical amplifier, to obtain an amplified multi-wavelength optical signal;
the optical receiver chip is configured to realize the separation and detection of multi-channel scattering lights in a mechanism of wavelength division, to obtain a photoelectric sounding signal;
the signal conditioning and acquisition chip is configured to perform amplification, filtering, and quantization on the photoelectric sounding signal, to obtain an independent n-channel demodulation result;
the digital signal processing chip is configured to perform demodulation, multi-dimensional feature extraction, pattern recognition, human-computer interaction, and data communication; and
the low-voltage DC electric drive module is configured to drive and control the optical transmitter chip, the integrated optical amplification module, the optical receiver chip, the signal conditioning and acquisition chip, and the digital signal processing chip that are sequentially connected. Centralized control of timing synchronization, and drive and control requirements between the modules in the system is performed, to implement low power consumption and low noise in a highly integrated way.

Further, the optical transmitter chip includes an array of narrow-linewidth light sources and the optical pulse modulator that are sequentially connected.

The array of narrow-linewidth light sources is configured to output pulsed light at different frequencies.

Specifically, the array of narrow-linewidth light sources is developed based on a reconstruction-equivalent chirp (REC) grating technology, and the linewidth, a central wavelength, and stability of the array are mainly determined by a sampling grating in a laser cavity. In the REC technology, the apodization of a sampling function is performed with reference to the chirp of a sampling period, to obtain a target reflection (or transmission) spectrum with the same performance as the true apodization, and the true chirp of the grating period. Uniform seed grating preparation is achieved through one-step holographic exposure, and a one-step micron-scale lithography process forms a sampling structure, to lower the requirements of grating preparation by equivalently realizing a complex grating structure such as chirping, phase shifting, and apodization that require nanoscale processes. If a +1 sub-grating is selected as a laser resonance wavelength range, a relative change of the period of the +1 sub-grating is:

$$Δ {Λ}_{+ 1} = \frac{1}{{( \frac{p}{{Λ}_{0}} + 1 )}^{2}} Δ P .$$

In the formula, P is the sampling period, ΔP is an abrupt change length of a specific position in the sampling grating, and Λ₀ is the grating period.

In terms of a laser cavity structure, a high-performance feedback cavity structure is generated by using the REC technology. The process is compatible with a conventional DFB diode laser by adding micron-scale lithography.

The optical pulse modulator is configured to process the pulsed light at different frequencies output by the array of narrow-linewidth light sources, including single-sideband frequency modulation and pulse shaping of intensity modulation, to obtain probe pulses in a mechanism of wavelength division and multi-domain multiplexing measurement.

Furthermore, the single-sideband frequency modulation includes a nested Mach-Zehnder interferometer structure including a plurality of electro-optic phase shifters, to change a refractive index of an optical waveguide through adding an external electrical signal, so that a phase of an output optical signal changes with a change of the external electrical signal, and finally completes the electro-optic modulation.

Intensity modulation pulse shaping is performed by using a broadband Mach-Zehnder M Z structure, and a high extinction ratio is achieved at a plurality of wavelengths by balancing a loss of two arms of a Mach-Zehnder interferometer, and the ratio of the extinction ratio ER to light transmittance of the two arms r satisfies the following relationship:

$$E R ∼ 20 {log}_{10} ( 1 + \sqrt{r} ) / ( 1 - \sqrt{r} ) .$$

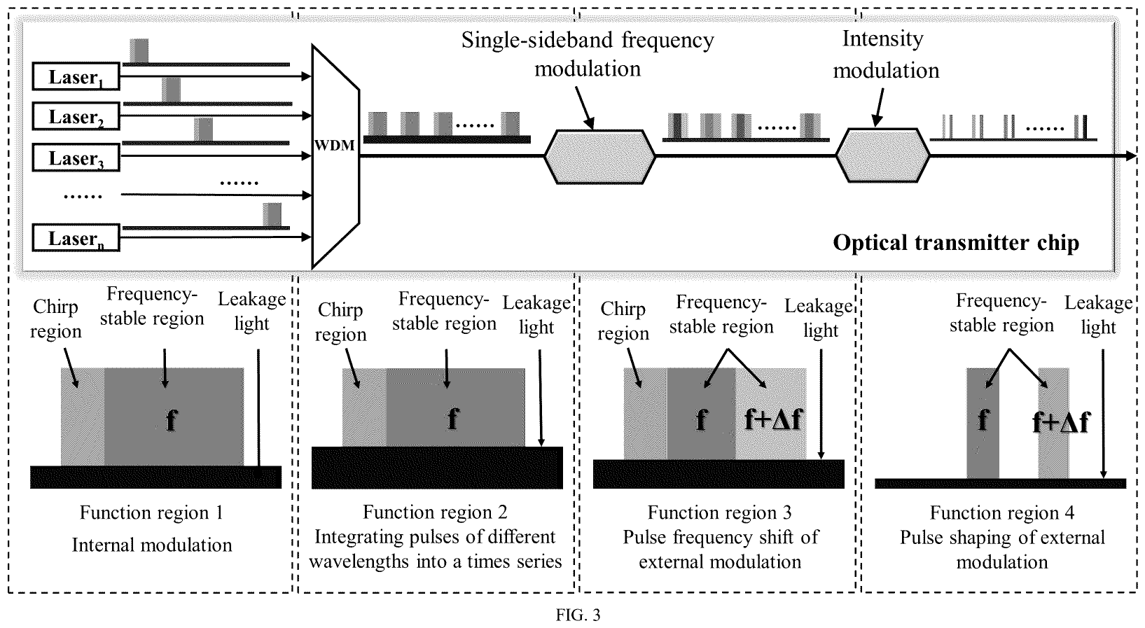

Further, FIG. 3 shows a structure and a working principle of the optical transmitter chip: the pulsed light is processed based on serial cascade modulation (specifically implemented in the pulsed light modulator), to make the extinction ratio meet requirements of the DAS system, including the following steps:
(1) alternately turning on each laser inside the array of narrow-linewidth light sources at equal intervals in time domain, to form a pulse with the width of us, and achieve the central wavelength of the laser precisely through the reconstruction-equivalent chirp (REC) grating technology;
(2) combining the pluses of n wavelengths generated by a multi-wavelength laser array by a wavelength division multiplexer, thus forming a pulse sequence in time sequence;
(3) dividing a frequency-stable region inside the pulsed light into two symmetrical halves through external time-synchronous modulation, where the frequency of the last half of the pulse will be shifted by Δf, so that a chirp region with a continuous frequency change and two stable regions with frequencies fand f+Δf are formed in a single pulse; and
(4) by using a broadband Mach Zehnder M Z modulator structure, precisely balancing the loss of two arms of a Mach Zehnder interferometer, to achieve high extinction ratio pulse shaping of multiple wavelength pulse signals provided by the laser array chip simultaneously; removing the chirp region; and further chopping the frequency-stable region into two sub-pulses of frequencies fand f+Δf with better rectangular coefficients, where each of pulse widths of the two generated sub-pulses is reduced to tens of ns, with an interval of hundreds of ns.

The frequency difference Δf of two sub-pulses and a pulse width τ meet the following relationship:

$$Δ f > \frac{1}{τ} .$$

Specifically, to meet requirements of system miniaturization, the integrated optical amplification module is integrated in the way of common pumping and drive, to obtain a compact module based on discrete devices. The integrated optical amplification module adopts a two-stage control mode to implement the flexible control and adjustment of the power amplification and low-noise amplification gain, where the first-stage control is the control of an output of a pumping light source and output light intensity by a control module, and the second-stage control includes the control of a two-stage constant power control signal on an attenuator size of the power amplifier, and the control of a two-stage constant gain control signal on an attenuator size of the low-noise amplifier.

Further, the optical receiver chip includes a wavelength division demultiplexer and a plurality of photodetectors (PD₁, PD₂, . . . , and PDₙ) connected in parallel with the wavelength division demultiplexer;
the wavelength division demultiplexer is connected to the low-noise optical amplifier; and
the wavelength division demultiplexer separates the multi-wavelength optical signal after low-noise optical amplification into independent n-channel output signals, and then performs photoelectric conversion on the multi-wavelength optical signal into an electrical signal through the plurality of photodetectors arranged in parallel.

Specifically, for the wavelength division demultiplexer of the DAS system, series micro-resonant cavity filters are used, and combined with features of a large refractive index difference of a silicon optical waveguide, an annular micro-resonant cavity is constructed with a small turning radius of 3-5 μm, and a large free spectral range is obtained through a small circumference of the resonant cavity. Each micro-resonant cavity filter may separate a signal of a wavelength channel, and a heater is used to adjust a resonant wavelength through the thermo-optical effect, to accurately and stably control a central wavelength of each micro-resonant cavity filter. A plurality of resonant cavities are coupled, and features of a steep roll-off (roll-off) between a spectral band pass and a bandgap, and low crosstalk between different wavelength channels are realized.

Further, the signal conditioning and acquisition chip includes a plurality of signal conditioning and acquisition branches with a same quantity as the photodetectors, each signal conditioning and acquisition branch includes a trans-impedance amplifier (TIA), a band-pass filter (BPF), and an analog-to-digital converter (ADC) that are sequentially connected, and the trans-impedance amplifier is connected to the photodetector.

Specifically, signal conditioning, acquisition, and processing are performed on the photoelectric signal, to obtain an independent n-channel demodulation result. If a pulse repetition frequency of a single channel is fₛ, an equivalent pulse repetition frequency of nfₛ can be obtained after interpolation, and an upper limit of the frequency response may theoretically reach nfₛ/2.

Further, the digital signal processing chip includes a digital demodulator, a reconfigurable neural network, and a microprocessor core that are sequentially connected. The microprocessor core is a RISC-V architecture microprocessor core.

Specifically, the DAS signal processing process based on the photonic integration system includes the following steps:
(1) perform parallel demodulation on electrical signals of different wavelengths, to obtain phase data of each wavelength with spatial variation;
(2) according to a time interval of switching between different wavelengths in an optical chip array and a sampling recovery moment of a digital signal, splice and combine the phase data obtained by different wavelengths in terms of time, where in this case, the data of three dimensions of wavelength, space, and time can be obtained;
(3) perform interpolation on the phase data after demodulation of the plurality of wavelengths in time domain, to obtain the distribution of phase changes along a time axis;
(4) according to a characteristic of a low probability that a plurality of independent measurement results are faded at adjacent moments and at the same position, and with reference to the method in terms of wavelength, space, and time, comprehensively realize the continuous dynamic optimization of multi-channel synchronous independent measurement results, and complete the reconstruction of the signal with high precision; and
(5) identify and classify events by using a reconfigurable network; and adjust the structure and the parameter of the network, to identify and classify different monitoring tasks of the sensing system, and improve scenario adaptability.

Further, the optical transmitter chip is generated by compound semiconductor technology, the optical receiver chip is generated by silicon photonic process, and functional parts inside the optical transmitter chip and functional parts inside the optical receiver chip are bonded by photonic wire bonding (PWB), and the optical transmitter chip to the single-mode optical fiber and the optical receiver chip to the single-mode optical fiber are bonded by photonic wire bonding (PWB) as well, to greatly reduce the size, the weight, and the power consumption of the system, and enhance the environmental adaptability.

The optical transmitter chip and the optical receiver chip are close in space and merged into a unified package, and electrical pins are directly bound to a circuit board through a wire bonder after the chips are packaged.

Pumping light sources in the optical transmitter chip, the optical receiver chip, and the integrated optical amplification module are concentrated in a specific area on the circuit board for unified constant temperature control.

The low-voltage DC electric drive module performs centralized control on the transmitter chip, the integrated optical amplification module, the optical receiver chip, the signal conditioning and acquisition chip, and the digital signal processing chip in the system, and functions include temperature control, abnormal protection, gain stability, power drive, and timing control, and dedicated functions of human-machine interface, watchdog, low-power sleep, and high-precision reference are further included.

Further, the signal conditioning and acquisition chip is soldered onto the circuit board in the form of a single chip of hybrid circuits; the digital signal processing chip is soldered onto the circuit board in the form of a single chip of pure digital circuits; and the two chips are interconnected through microstrip lines on the circuit board.

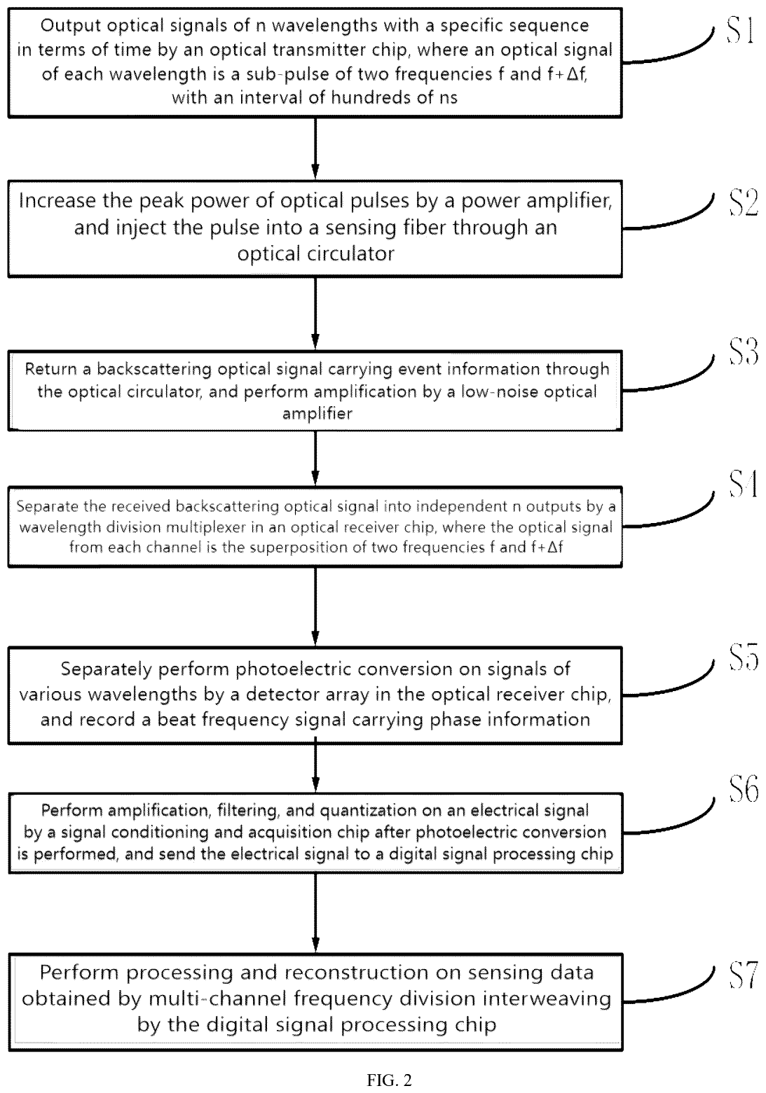

Corresponding to the system described in FIG. 1, the present invention further discloses a photonic-integrated distributed acoustic sensing system with long-distance and wide-frequency response, applied to the photonic-integrated distributed acoustic sensing system with long-distance and wide-frequency response according to FIG. 1. Specific steps are shown in FIG. 2.
S1: Output optical signals of n wavelengths with a specific sequence in terms of time by an optical transmitter chip, where an optical signal of each wavelength is a sub-pulse of two frequencies fand f+Δf, with an interval of hundreds of ns.
S2: Increase the peak power of optical pulses by a power amplifier, and inject the pulse into a sensing fiber through an optical circulator.
S3: Return a backscattering optical signal carrying event information through the optical circulator, and perform amplification by a low-noise optical amplifier.
S4: Separate the backscattering optical signal into independent n-channel outputs by a wavelength division demultiplexer in an optical receiver chip, where the optical signal from each channel is the superposition of two frequencies fand f+Δf.
S5: Separately perform photoelectric conversion on signals of various wavelengths by a detector array in the optical receiver chip, and record a beat frequency signal carrying phase information.
S6: Perform amplification, filtering, and quantization on an electrical signal by a signal conditioning and acquisition chip after photoelectric conversion is performed, and send the electrical signal to a digital signal processing chip.
S7: Perform processing and reconstruction on sensing data obtained by multi-channel frequency division interweaving by the digital signal processing chip.

When the system of the present invention starts the measurement, the pulse sequences including a plurality of different wavelengths required by the DAS system are first synthesized by the optical transmitter chip. FIG. 3 shows a detection pulsed light synthesis solution in a mechanism of wavelength division and multi-domain multiplexing measurement, and the optical transmitter chip is divided into four functional regions in series.
(1) Functional region 1—Internal modulation: including a laser array of n wavelengths that are different from each other. When the system starts the measurement, each laser inside the array is alternately turned on at equal intervals in time domain, and a pulse with the width of us is formed through internal modulation. In a short slot after the laser is turned on, there is a chirp region of a specific length, but the frequency of the pulsed light is soon stabilized and remains at f. When the laser is turned off, there is some degree of leakage of light.
(2) Functional region 2—Integrating pulses of different wavelengths into a time series: the pluses of n wavelengths are combined by a wavelength division multiplexer, to form a pulse sequence in time sequence, and realize the multiplexing of a measurement system in time domain and wavelength domain. Because there is leakage light in each wavelength output, the leakage light level of the pulsed light sequence after wave combination may be increased by n times, resulting in a decrease in the extinction ratio. However, the decline is not significant for any single wavelength.
(3) Functional region 3—Pulse frequency shift of external modulation: implemented by a single-sideband frequency modulator. A frequency-stable region inside the pulsed light is divided by the area into two halves of approximately symmetry through external time-synchronous modulation, where the frequency of the last half of the pulse will be shifted by Δf. In this case, a chirp region with a continuous frequency change and two stable regions with frequencies fand f+Δf are formed in a single pulse. The modulator may suppress the leakage light to a specific extent, and the extinction ratio may be increased.
(4) Functional region 4—Pulse shaping of external modulation: the pulse shaping is realized by an intensity modulator, a chirp region is removed, and a frequency-stable region is further chopped into two sub-pulses of frequencies f and f+Δf with better rectangular coefficients. Each of pulse widths of the two generated sub-pulses is reduced to tens of ns, with an interval of hundreds of ns. The modulator further suppresses the leakage light.

The control of the pulse width and the pulse repetition frequency of the pulsed light is realized by an embedded control circuit, and a host computer obtains a value of the pulse width and the pulse repetition frequency that needs to be changed through serial communication, and writes the value into an electrically erasable programmable read-only memory (E²PROM), and sends the value to a complex programmable logic device (CPLD). The CPLD obtains a primary clock from an oscillator and outputs two pulses based on received information. One is a control electrical pulse, where the pulse width and pulse repetition frequency are consistent with those in the control information sent by a controller, and are received by an A OM drive after passing through a buffer; and the other is a synchronous pulse, where the synchronous pulse is fully synchronized with the control pulse, but a pulse width is fixed, and is used as a synchronous trigger signal for an acquisition card. An adjustment step of the pulse width of the system is 10 ns, and implemented by a pulse width modulation (PW M) wave peripheral module with a main frequency of 100 M Hz. The CPLD plans to use the Compact PGC4KLS manufactured by a domestic manufacturer named Shenzhen Pango Microsystems Co., Ltd. The EEPROM uses the FM 24C 08A manufactured by Shanghai Fudan Microelectronics Group Co., Ltd, to store values of the pulse width and the pulse repetition frequency. Even if a control command from the controller is not received after the microcontroller is powered on, the CPLD can be controlled to output pulses normally at a default value set by the last power-on.

After the detection pulsed light sequences are synthesized, the sequence enters the integrated optical amplification module, and the peak power of the pulse is increased by the power amplifier, and the pulse is injected into a sensing fiber through the optical circulator. A backscattering optical signal returned by the optical circulator further includes a plurality of wavelengths due to the fact that the pulse injected into the sensing fiber includes a plurality of wavelengths; and the backscattering light is amplified through the low-noise optical amplifier.

The optical signal amplified through low noise optical amplification is divided into independent n-channel outputs through a wavelength division demultiplexer, and the photoelectric conversion is performed through the photodetector array. After amplification, conditioning, and acquisition are performed on the electrical signal by the signal conditioning and acquisition chip, an independent n-channel digital signal is obtained. A signal conditioning circuit mainly includes an amplifier and two band-pass filters with a central frequency of 50 MHz. An electrical signal output by the detector passes through a first band-pass filter, and after filtering out most of the noise, the amplifier amplifies the electrical signal to a range close to the range of the acquisition card. Because noise is inevitably introduced during amplifier amplification, the amplified signal is filtered out by a second band-pass filter and then captured by the acquisition card. The filter and amplifier are a standard device 7B N 01B 5-50 filter and a FD-9NH 15NL F 03-100 amplifier of Boya Electronics, respectively, and the CB M 96/94 series ADC of Corebai is selected for digital signal acquisition.

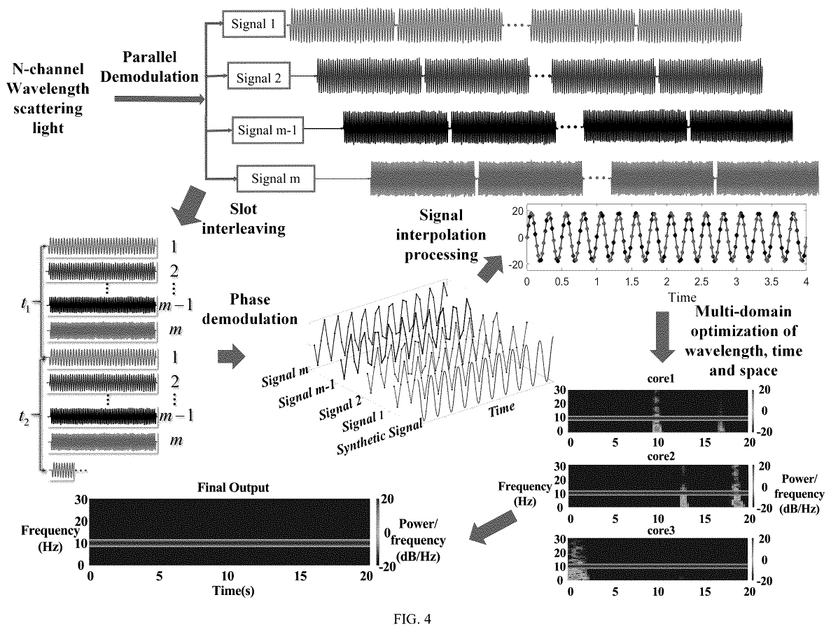

A digital signal is further processed by the digital signal processing chip with a lightweight and migratory algorithm, as shown in FIG. 4. Parallel demodulation is performed on electrical signals of different wavelengths, to obtain phase data of each wavelength with spatial variation. Then, according to a time interval of switching between different wavelengths in an optical chip array and a sampling recovery moment of a digital signal, the phase data obtained by different wavelengths in terms of time are spliced and combined. In this case, the data of three dimensions of wavelength, space, and time can be obtained. Interpolation is performed on the phase data of the plurality of wavelengths in time domain, to obtain the distribution of phase changes along a time axis. According to a characteristic of a low probability that a plurality of independent measurement results are faded at adjacent moments and at the same position, and with reference to the method in terms of wavelength, space, and time, the continuous dynamic optimization of multi-channel synchronous independent measurement results is comprehensively realized, and the reconstruction of the signal with high precision is completed. Finally, events are identified and classified by using a reconfigurable network; and the structure and the parameters of the network are adjusted, to identify and classify different monitoring tasks of the sensing system, and improve scenario adaptability.

Each embodiment in this specification is described in a progressive manner, the same and similar parts between each embodiment can refer to each other, and each embodiment focuses on differences from other embodiments. In particular, for a system or a system embodiment, because the system and the system embodiment are basically similar to a method embodiment, details are simply described. For relevance, refer to a part of the descriptions of the method embodiment. The system and system embodiment described above is merely an example. The units described as separate parts may or may not be physically separate, and parts displayed as units may or may not be physical units, may be located in one position, or may be distributed on a plurality of network units. Some or all the modules may be selected according to actual needs to achieve the objectives of the solutions of embodiments. A person of ordinary skill in the art may understand and implement embodiments of the present invention without creative efforts.

The foregoing descriptions of the disclosed embodiments enable a person skilled in the art to implement or use the present invention. The various modifications to the embodiments are clear to a person skilled in the art, and the general principles defined herein may be implemented in another embodiment without departing from the spirit or scope of the present invention. Therefore, the present invention is not limited to the embodiments shown herein, but the present invention needs to conform to the widest range consistent with the principles and novel features disclosed herein.

What is claimed is:

1. A photonic-integrated distributed acoustic sensing system with a long-distance and wide-frequency response, comprising: a low-voltage direct current (DC) electric drive module, an optical transmitter chip, an integrated optical amplification module, an optical receiver chip, a signal conditioning and acquisition chip, and a digital signal processing chip, wherein the low-voltage DC electric drive module, the optical transmitter chip, the integrated optical amplification module, the optical receiver chip, the signal conditioning and acquisition chip, and the digital signal processing chip are sequentially connected, wherein
the optical transmitter chip is configured to synthesize pulse sequences comprising a plurality of different wavelengths required by a distributed acoustic sensing (DAS) system;
the integrated optical amplification module comprises an optical power amplifier, an optical circulator, and a low-noise optical amplifier, wherein the optical power amplifier, the optical circulator, and the low-noise optical amplifier are sequentially connected, wherein the optical circulator is further connected to a sensing fiber; the optical power amplifier is connected to an optical pulse modulator, to increase a peak power of a pulse; the pulse is injected into the sensing fiber through the optical circulator, and a backscattering optical signal returned by the optical circulator comprises a plurality of wavelengths due to the fact that the pulse injected into the sensing fiber comprises a plurality of wavelengths; and the backscattering optical signal is amplified through the low-noise optical amplifier, to obtain an amplified multi-wavelength optical signal;
the optical receiver chip is configured to realize a separation and a detection of multi-channel scattering lights in a mechanism of wavelength division, to obtain a photoelectric sounding signal;
the signal conditioning and acquisition chip is configured to perform an amplification, a filtering, and a quantization on the photoelectric sounding signal, to obtain an independent n-channel demodulation result;
the digital signal processing chip is configured to perform a demodulation, a multi-dimensional feature extraction, a pattern recognition, a human-computer interaction, and a data communication; and
the low-voltage DC electric drive module is configured to drive and control the optical transmitter chip, the integrated optical amplification module, the optical receiver chip, the signal conditioning and acquisition chip, and the digital signal processing chip.

2. The photonic-integrated distributed acoustic sensing system according to claim 1, wherein the optical transmitter chip comprises an array of narrow-linewidth light sources and the optical pulse modulator, wherein the array of narrow-linewidth light sources and the optical pulse modulator are sequentially connected, wherein
the array of narrow-linewidth light sources is configured to output a pulsed light at different frequencies; and
the optical pulse modulator is configured to process the pulsed light at different frequencies output by the array of narrow-linewidth light sources, comprising a single-sideband frequency modulation and a pulse shaping of intensity modulation, to obtain probe pulses in a mechanism of wavelength division and multi-domain multiplexing measurement.

3. The photonic-integrated distributed acoustic sensing system according to claim 2, wherein the pulsed light is processed based on a serial cascade modulation, to make an extinction ratio meet requirements of the DAS system, comprising the following steps:
1) alternately turning on each laser inside the array of narrow-linewidth light sources at equal intervals in a time domain, to form a pulse with a width of microseconds (us), and achieve a central wavelength of the laser precisely through a reconstruction-equivalent chirp (REC) technology;
2) combining pluses of n wavelengths generated by a multi-wavelength laser array by a wavelength division multiplexer, thus forming a pulse sequence in a time sequence;
3) dividing a frequency-stable region inside the pulsed light into two symmetrical halves through an external time-synchronous modulation, wherein a frequency of a pulse of a last half of the frequency-stable region inside the pulsed light will be shifted by Δf, so that a chirp region with a continuous frequency change and two stable regions with frequencies fand f+Δf are formed in a single pulse; and
4) by using a broadband Mach Zehnder (MZ) modulator structure, precisely balancing a loss of two arms of a Mach Zehnder interferometer, to achieve a high extinction ratio pulse shaping of a plurality of wavelength pulse signals provided by a laser array chip simultaneously, removing the chirp region; and further chopping the frequency-stable region into two sub-pulses of frequencies f and f+Δf with better rectangular coefficients, wherein each of pulse widths of the two sub-pulses is reduced to tens of ns, with an interval of hundreds of ns.

4. The photonic-integrated distributed acoustic sensing system according to claim 3, wherein regarding the two sub-pulses of a same wavelength with a frequency difference Δf, the frequency difference Δf and a pulse width τ meet the following relationship:
$$Δ f > \frac{1}{τ} .$$

5. The photonic-integrated distributed acoustic sensing system according to claim 1, wherein
the optical receiver chip comprises a wavelength division demultiplexer and a plurality of photodetectors connected in parallel with the wavelength division demultiplexer;
the wavelength division demultiplexer is connected to the low-noise optical amplifier; and
the wavelength division demultiplexer separates the amplified multi-wavelength optical signal after low-noise optical amplification into independent n-channel output signals, and then performs a photoelectric conversion on the amplified multi-wavelength optical signal into an electrical signal through the plurality of photodetectors arranged in parallel.

6. The photonic-integrated distributed acoustic sensing system according to claim 5, wherein
the signal conditioning and acquisition chip comprises a plurality of signal conditioning and acquisition branches with a same quantity as the plurality of photodetectors, each of the plurality of signal conditioning and acquisition branch comprises a trans-impedance amplifier, a band-pass filter, and an analog-to-digital converter, wherein the trans-impedance amplifier, the band-pass filter, and the analog-to-digital converter are sequentially connected, and the trans-impedance amplifier is connected to the photodetector.

7. The photonic-integrated distributed acoustic sensing system according to claim 6, wherein
the digital signal processing chip comprises a digital demodulator, a reconfigurable neural network, and a microprocessor core, wherein the digital demodulator, the reconfigurable neural network, and the microprocessor core are sequentially connected.

8. The photonic-integrated distributed acoustic sensing system according to claim 1, wherein
the optical transmitter chip is produced by a compound semiconductor technology, the optical receiver chip is produced by a silicon photonic process, and functional parts inside the optical transmitter chip and functional parts inside the optical receiver chip are bonded by photonic wire bonding (PWB), and the optical transmitter chip to a single-mode optical fiber and the optical receiver chip to the single-mode optical fiber are bonded by the PWB as well;
the optical transmitter chip and the optical receiver chip are adjacent in space and merged into a unified package, and electrical pins are directly bound to a circuit board through a wire bonder after the optical transmitter chip and the optical receiver chip are packaged;
pumping light sources in the optical transmitter chip, the optical receiver chip, and the integrated optical amplification module are concentrated in an area on the circuit board for a unified constant temperature control; and
the low-voltage DC electric drive module performs a centralized control on the optical transmitter chip, the integrated optical amplification module, the optical receiver chip, the signal conditioning and acquisition chip, and the digital signal processing chip in the DAS system, and functions comprise a temperature control, an abnormal protection, a gain stability, a power drive, and a timing control, and a dedicated functions of a human-machine interface, a watchdog, a low-power sleep, and a high-precision reference are further comprised.

9. The photonic-integrated distributed acoustic sensing system according to claim 8, wherein
the signal conditioning and acquisition chip is soldered onto the circuit board in a form of a single chip of hybrid circuits; the digital signal processing chip is soldered onto the circuit board in a form of a single chip of pure digital circuits; and the signal conditioning and acquisition chip and the digital signal processing chip are interconnected through microstrip lines on the circuit board.

10. A photonic-integrated distributed acoustic sensing method, applied to the photonic-integrated distributed acoustic sensing system according to claim 1, and comprising the following steps:
S1: outputting optical signals of n wavelengths with a sequence in terms of time by the optical transmitter chip, wherein an optical signal of each of the n wavelengths is a sub-pulse of two frequencies fand f+Δf, with an interval of hundreds of ns,
S2: increasing the peak power of the pulse by the optical power amplifier, and injecting the pulse into the sensing fiber through the optical circulator;
S3: returning the backscattering optical signal carrying event information through the optical circulator, and performing the amplification by the low-noise optical amplifier;
S4: separating the backscattering optical signal into independent n outputs by a wavelength division multiplexer in the optical receiver chip, wherein an optical signal from each channel is a superposition of the two frequencies fand f+Δf,
S5: separately performing a photoelectric conversion on signals of the plurality of wavelengths by a detector array in the optical receiver chip, and recording a beat frequency signal carrying phase information;
S6: performing the amplification, the filtering, and the quantization on an electrical signal by the signal conditioning and acquisition chip after the photoelectric conversion is performed, and sending the electrical signal to the digital signal processing chip; and
S7: performing a processing and a reconstruction on sensing data obtained by a multi-channel frequency division interweaving by the digital signal processing chip.

11. The photonic-integrated distributed acoustic sensing method according to claim 10, wherein in the photonic-integrated distributed acoustic sensing system, the optical transmitter chip comprises an array of narrow-linewidth light sources and the optical pulse modulator, wherein the array of narrow-linewidth light sources and the optical pulse modulator are sequentially connected, wherein
the array of narrow-linewidth light sources is configured to output a pulsed light at different frequencies; and
the optical pulse modulator is configured to process the pulsed light at different frequencies output by the array of narrow-linewidth light sources, comprising a single-sideband frequency modulation and a pulse shaping of intensity modulation, to obtain probe pulses in a mechanism of wavelength division and multi-domain multiplexing measurement.

12. The photonic-integrated distributed acoustic sensing method according to claim 11, wherein in the photonic-integrated distributed acoustic sensing system, the pulsed light is processed based on a serial cascade modulation, to make an extinction ratio meet requirements of the DAS system, comprising the following steps:
1) alternately turning on each laser inside the array of narrow-linewidth light sources at equal intervals in a time domain, to form a pulse with a width of microseconds (us), and achieve a central wavelength of the laser precisely through a reconstruction-equivalent chirp (REC) technology;
2) combining pluses of n wavelengths generated by a multi-wavelength laser array by a wavelength division multiplexer, thus forming a pulse sequence in a time sequence;
3) dividing a frequency-stable region inside the pulsed light into two symmetrical halves through an external time-synchronous modulation, wherein a frequency of a pulse of a last half of the frequency-stable region inside the pulsed light will be shifted by Δf, so that a chirp region with a continuous frequency change and two stable regions with frequencies fand f+Δf are formed in a single pulse; and
4) by using a broadband Mach Zehnder (MZ) modulator structure, precisely balancing a loss of two arms of a Mach Zehnder interferometer, to achieve a high extinction ratio pulse shaping of a plurality of wavelength pulse signals provided by a laser array chip simultaneously, removing the chirp region; and further chopping the frequency-stable region into two sub-pulses of frequencies f and f+Δf with better rectangular coefficients, wherein each of pulse widths of the two sub-pulses is reduced to tens of ns, with an interval of hundreds of ns.

13. The photonic-integrated distributed acoustic sensing method according to claim 12, wherein in the photonic-integrated distributed acoustic sensing system, regarding the two sub-pulses of a same wavelength with a frequency difference Δf, the frequency difference Δf and a pulse width τ meet the following relationship:
$$Δ f > \frac{1}{τ} .$$

14. The photonic-integrated distributed acoustic sensing method according to claim 10, wherein in the photonic-integrated distributed acoustic sensing system, the optical receiver chip comprises a wavelength division demultiplexer and a plurality of photodetectors connected in parallel with the wavelength division demultiplexer;
the wavelength division demultiplexer is connected to the low-noise optical amplifier; and
the wavelength division demultiplexer separates the amplified multi-wavelength optical signal after low-noise optical amplification into independent n-channel output signals, and then performs a photoelectric conversion on the amplified multi-wavelength optical signal into an electrical signal through the plurality of photodetectors arranged in parallel.

15. The photonic-integrated distributed acoustic sensing method according to claim 14, wherein in the photonic-integrated distributed acoustic sensing system, the signal conditioning and acquisition chip comprises a plurality of signal conditioning and acquisition branches with a same quantity as the plurality of photodetectors, each of the plurality of signal conditioning and acquisition branch comprises a trans-impedance amplifier, a band-pass filter, and an analog-to-digital converter, wherein the trans-impedance amplifier, the band-pass filter, and the analog-to-digital converter are sequentially connected, and the trans-impedance amplifier is connected to the photodetector.

16. The photonic-integrated distributed acoustic sensing method according to claim 15, wherein in the photonic-integrated distributed acoustic sensing system, the digital signal processing chip comprises a digital demodulator, a reconfigurable neural network, and a microprocessor core, wherein the digital demodulator, the reconfigurable neural network, and the microprocessor core are sequentially connected.

17. The photonic-integrated distributed acoustic sensing method according to claim 10, wherein in the photonic-integrated distributed acoustic sensing system, the optical transmitter chip is produced by a compound semiconductor technology, the optical receiver chip is produced by a silicon photonic process, and functional parts inside the optical transmitter chip and functional parts inside the optical receiver chip are bonded by photonic wire bonding (PWB), and the optical transmitter chip to a single-mode optical fiber and the optical receiver chip to the single-mode optical fiber are bonded by the PWB as well;
the optical transmitter chip and the optical receiver chip are adjacent in space and merged into a unified package, and electrical pins are directly bound to a circuit board through a wire bonder after the optical transmitter chip and the optical receiver chip are packaged;
pumping light sources in the optical transmitter chip, the optical receiver chip, and the integrated optical amplification module are concentrated in an area on the circuit board for a unified constant temperature control; and
the low-voltage DC electric drive module performs a centralized control on the optical transmitter chip, the integrated optical amplification module, the optical receiver chip, the signal conditioning and acquisition chip, and the digital signal processing chip in the DAS system, and functions comprise a temperature control, an abnormal protection, a gain stability, a power drive, and a timing control, and a dedicated functions of a human-machine interface, a watchdog, a low-power sleep, and a high-precision reference are further comprised.

18. The photonic-integrated distributed acoustic sensing method according to claim 17, wherein in the photonic-integrated distributed acoustic sensing system, the signal conditioning and acquisition chip is soldered onto the circuit board in a form of a single chip of hybrid circuits; the digital signal processing chip is soldered onto the circuit board in a form of a single chip of pure digital circuits; and the signal conditioning and acquisition chip and the digital signal processing chip are interconnected through microstrip lines on the circuit board.
